(19) United States
(12) Patent Application Publication
(10) Pub. No.: US 2023/0255848 A1
(43) Pub. Date: Aug. 17, 2023

(54) FOREARM SYNERGY TRAINING DEVICE

(71) Applicant: National Cheng Kung University, Tainan City (TW)

(72) Inventors: Hsiu-Yun HSU, Tainan City (TW); Li-Chieh KUO, Tainan City (TW); Fong-Chin SU, Tainan City (TW); Kang-Chin YANG, Pingtung County (TW)

(21) Appl. No.: 17/835,784

(22) Filed: Jun. 8, 2022

(30) Foreign Application Priority Data
Feb. 11, 2022 (TW) 111105048

(51) Int. Cl. A61H 1/02

(52) U.S. Cl. CPC A61H 1/0285; A61H 2201/1671; A61H 2201/1638; A61H 2201/149; A61H 2201/1269

(57) ABSTRACT

A forearm synergy training device includes a support swingable on a base and having an arcuate sliding rail portion, a sliding unit movable on the arcuate sliding rail portion, and a synergistic assembly connected to the base, the support and the sliding unit for driving the sliding unit to slide along the arcuate sliding rail portion when the support is swung. A wearable unit is removably disposed on the support and the sliding unit, and is sleeved on a hand and a forearm of a user. When the user's elbow bends, the support is swung by the forearm through the wearable unit, so that the hand and the forearm are driven by the sliding unit to rotate along the arcuate sliding rail portion.

### CROSS-REFERENCE TO RELATED APPLICATION

This application claims priority to Taiwanese Patent Application No. 111105048, filed on Feb. 11, 2022.

### FIELD

The disclosure relates to a training device, and more particularly to a forearm synergy training device.

### BACKGROUND

In occupational therapy, rehabilitation of a patient's forearm relies on an assistive device for training hand muscles. However, the current forearm rehabilitation device on the market can only assist a patient to bend the patient's forearm for training. The patient is unable to simultaneously rotate the forearm while bending the forearm in association with exercising other fine hand movements such as scooping and picking up.

A wearable forearm active rehabilitation training exoskeleton device, as disclosed in Chinese Patent Publication No. CN108524192A, includes an exoskeleton support, an elbow flexion-extension mechanism, a forearm rotation mechanism, a driving motor unit, and a myoelectric signal acquisition device.

The exoskeleton support is used for fixing a patient's upper limb and for supporting the elbow flexion-extension mechanism and the forearm rotation mechanism. The myoelectric signal acquisition device is buried within the exoskeleton support to detect myoelectric signals generated from muscular tension of the patent's upper limb. The driving motor unit includes a first driving motor and a second driving motor. The first driving motor is used for supplying electric power to the elbow flexion-extension mechanism. The second driving motor is used for supplying electric power to the forearm rotation mechanism. Thus, by virtue of the electric power provided by the driving motor unit, the elbow flexion-extension mechanism and the forearm rotation mechanism drive stretching and rotating exercises of the patient's upper limb.

However, the wearable forearm active rehabilitation training exoskeleton device has to rely on the electric power provided by the driving motor unit to drive the stretching and rotating exercises of the patient's upper limb, and the overall structure thereof is complicated. In addition, without electric power supply, the wearable forearm active rehabilitation training exoskeleton device is inoperable, thereby causing inconvenience in use.

### SUMMARY

Therefore, an object of the disclosure is to provide a forearm synergy training device that can alleviate at least one of the drawbacks of the prior art.

According to the disclosure, the forearm synergy training device includes an assistive unit and a wearable unit.

The assistive unit includes a base, a support, a sliding unit, and a synergistic assembly. The support is swingable in a front-rear direction relative to and disposed on the base, and has an arcuate sliding rail portion. The sliding unit is movably disposed on the arcuate sliding rail portion. The synergistic assembly is connected to the base, the support and the sliding unit. The synergistic assembly drives the sliding unit to slide along the arcuate sliding rail portion when the support is swung relative to the base.

The wearable unit is removably disposed on the support and the sliding unit, and is adapted to be sleeved on a hand and a forearm of a user. When the user's elbow bends, the support is swung by the forearm through the wearable unit, so that the hand and the forearm are driven by the sliding unit to rotate along the arcuate sliding rail portion.

### BRIEF DESCRIPTION OF THE DRAWINGS

Other features and advantages of the disclosure will become apparent in the following detailed description of the embodiment with reference to the accompanying drawings, of which:

FIG. 1 is a partly exploded perspective view illustrating a forearm synergy training device according to an embodiment of the disclosure;

FIG. 2 is a bottom perspective view of the embodiment, illustrating an assistive unit of the forearm synergy training device;

FIG. 3 is a perspective view of the embodiment, illustrating a wearable unit of the forearm synergy training device sleeved on a user's hand and forearm;

FIG. 4 is a schematic side view of the embodiment, illustrating the wearable unit disposed on a sliding unit of the forearm synergy training device;

FIG. 5 is a schematic front view of the embodiment, illustrating the sliding unit located under an arcuate sliding rail portion of a support of the assistive unit;

FIG. 6 is a schematic side view of the embodiment, illustrating a support swung relative to a base of the forearm synergy training device during using the forearm synergy training device; and

FIG. 7 is a schematic front view of the embodiment, illustrating the sliding unit sliding upwardly along the arcuate sliding rail portion.

### DETAILED DESCRIPTION

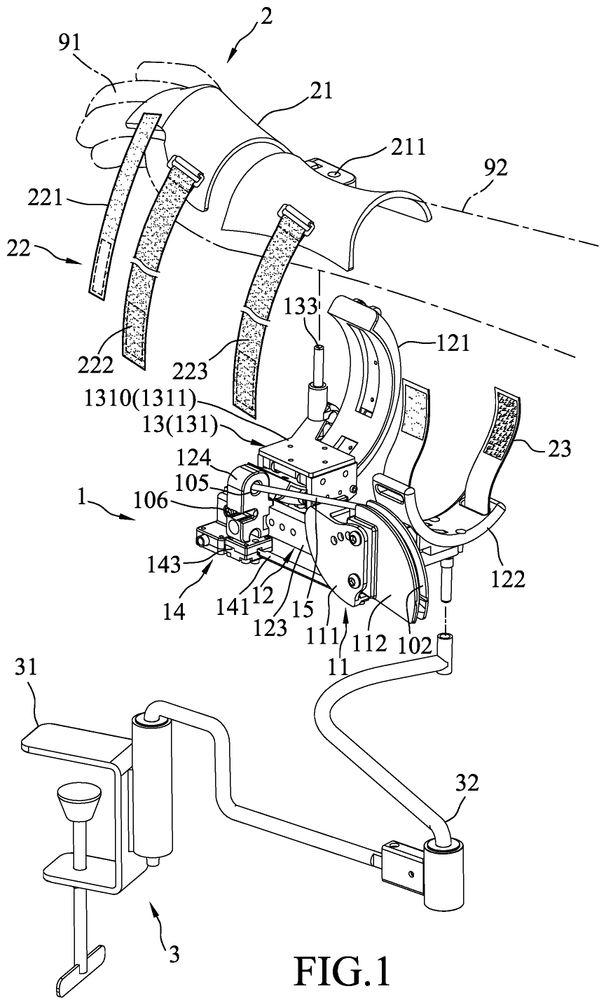

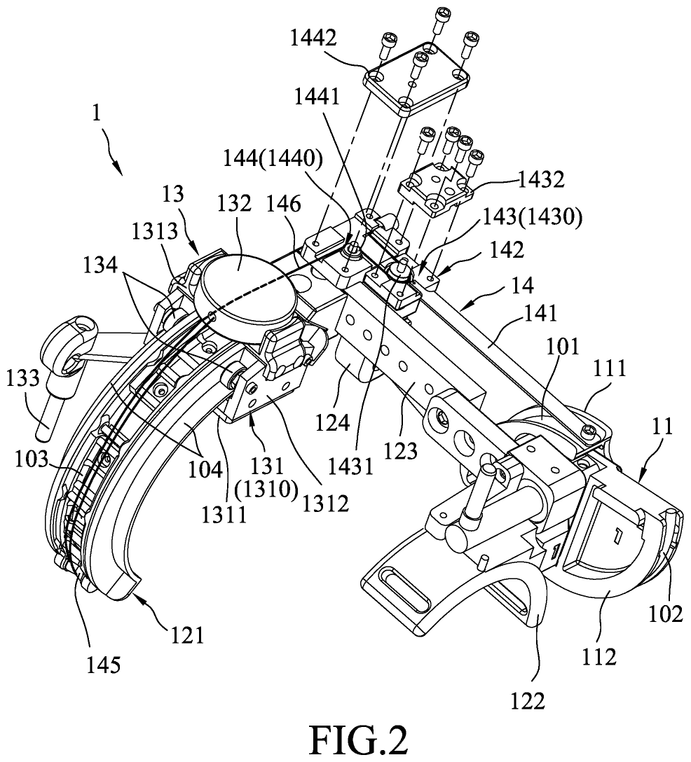

Referring to FIGS. 1 and 2, a forearm synergy training device according to an embodiment of the disclosure is wearable on a hand 91 and a forearm 92 of a user, and includes an assistive unit 1, a wearable unit 2, and a supporting frame 3.

The assistive unit 1 includes a base 11, a support 12, a sliding unit 13, a synergistic assembly 14, and an adjustment belt 15. The base 11 has a cord guiding plate 111 and a base plate 112. The cord guiding plate 111 has a first arcuate cord slot 101 formed in a bottom side thereof. The base plate 112 has a second arcuate cord slot 102 formed in a top side thereof.

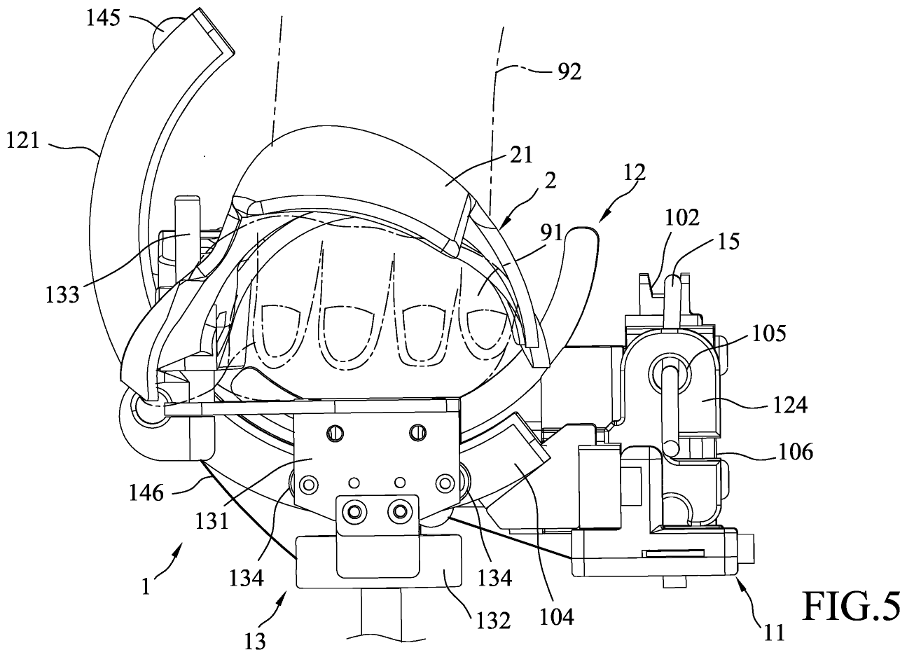

The support 12 is swingable in a front-rear direction relative to and disposed on the base 11, and has an arcuate sliding rail portion 121, a supporting portion 122, a connecting portion 123, and a fixing portion 124. The arcuate sliding rail portion 121 has a movable cord guide slot 103 formed in a bottom surface thereof, and two slide slots 104 respectively formed in front and rear sides of the arcuate sliding rail portion 121. The supporting portion 122 is rotatably connected to the base 11. The connecting portion 123 is connected between the arcuate sliding rail portion 121 and the supporting portion 122. The fixing portion 124 is disposed on an end of the connecting portion 123 opposite to the support portion 122. In this embodiment, the fixing portion 124 has an adjustment perforated hole 105 and a fixing slot 106 (see FIG. 5).

The sliding unit 13 is movably disposed on the arcuate sliding rail portion 121, and has a sliding block 131, a cord reel 132, a first fixing member 133, and a plurality of wheels 134. The sliding block 131 is slidably sleeved on the arcuate sliding rail portion 121, and has a main body 1310. The main body 1310 has a top wall 1311 on which the wearable unit 2 is disposed, two spaced-apart side walls 1312 extending respectively and downwardly from two opposite sides of the top wall 1311, and a bottom wall 1313 connected between the side walls 1312 and disposed under the top wall 1311. The cord reel 132 is disposed on the bottom wall 1313. The first fixing member 133 is disposed on the top wall 1311 of the sliding block 131. The wheels 134 are rotatably disposed on inner surfaces of the side walls 1312 and abut against the arcuate sliding rail portion 121. In this embodiment, the number of the wheels 134 is four. Two wheels 134 are rotatably disposed on the inner surface of one of the side walls 1312 and are engaged with one of the slide slots 104. The other two wheels 134 are rotatably disposed on the inner surface of the other one of the side walls 1312 and are engaged with the other one of the slide slots 104.

The synergistic assembly 14 is connected to the base 11, the support 12 and the sliding unit 13, and includes a fixed cord 141 and a pulley-and-cord unit 142. The fixed cord 141 is connected between the cord guiding plate 111 and the pulley-and-cord unit 142. When the support 12 is swung relative to the base 11, the fixed cord 141 is disposed around the first arcuate cord slot 101 and generates a pulling force pulling the pulley-and-cord unit 142 together with the sliding unit 13 to move toward the base 11.

The pulley-and-cord unit 142 is disposed movably on the support 12. An end of the pulley-and-cord unit 142 distal from the fixed cord 141 is fixed to the sliding unit 13. In this embodiment, the pulley-and-cord unit 142 has a movable pulley member 143 connected to the fixed cord 141, a first fixed pulley member 144 disposed on a bottom side of the connecting portion 123, a second fixed pulley member 145 disposed on a bottom end of the arcuate sliding rail portion 121 distal from the connecting portion 123, and a movable cord 146 connected between the connecting potion 123 and the sliding unit 13. The movable pulley member 143 has a pulley seat 1430 disposed on the connecting portion 123 of the support 12, a movable pulley 1431 rotatably disposed on the pulley seat 1430, and a movable cover 1432 covering the pulley seat 1430. The first fixed pulley member 144 has a first fixed pulley seat 1440 disposed on the connecting portion 123 of the support 12, a first fixed pulley 1441 rotatably disposed on the first fixed pulley seat 1440, and a first fixed cover 1442 covering the first fixed pulley seat 1440. The sliding unit 13 is disposed between the first fixed pulley member 144 and the second fixed pulley member 145. The movable cord 146 is disposed around the movable pulley 1431, the first fixed pulley member 144, and the second fixed pulley member 145. One end of the movable cord 146 is fixed to the connecting portion 123, and the other end of the movable cord 146 is connected to the cord reel 132 of the sliding unit 13. The movable cord 146 moves the sliding unit 13 toward the second fixed pulley member 145 through the pulling force generated by the fixed cord 141 when the support 12 is swung relative to the base 11. When the pulling force is applied to move the sliding unit 13, the movable cord 146 is wound resiliently on the cord reel 132. The cord reel 132 prevents the movable cord 146 from loosening and disengaging from the movable cord guide slot 103 of the arcuate sliding rail portion 121 during self-rotation of the hand 91 and forearm 92 of the user.

One end of the adjustment belt 15 is fixed to the base plate 112 of the base 11. The adjustment belt is disposed around the second arcuate cord slot 102 of the base plate 112, extends through the adjustment perforated hole 105 of the fixing portion 124, and is fixed into the fixing slot 106 of the fixing portion 124 at the other end thereof. As such, the adjustment belt 15 is connected between the base 11 and the fixing portion 124 of the support 12 under tension. The adjustment belt 15 is operable to adjust an initial inclination angle of the support 12 relative to the base 11, thereby adjusting swing amplitude of the user's forearm 92.

The wearable unit 2 includes a protective body 21, a first strap set 22, and a second strap 23. The protective body 21 is removably disposed on a top side of the sliding unit 13 for being sleeved on the hand 91 and the forearm 92. The wearable unit 2 further includes a second fixing member 211 that is disposed on the protective body 21 and that is engaged with the first fixing member 133 of the sliding unit 13. In this embodiment, the first fixing member 133 is a pin, and the second fixing member 211 is a perforated hole.

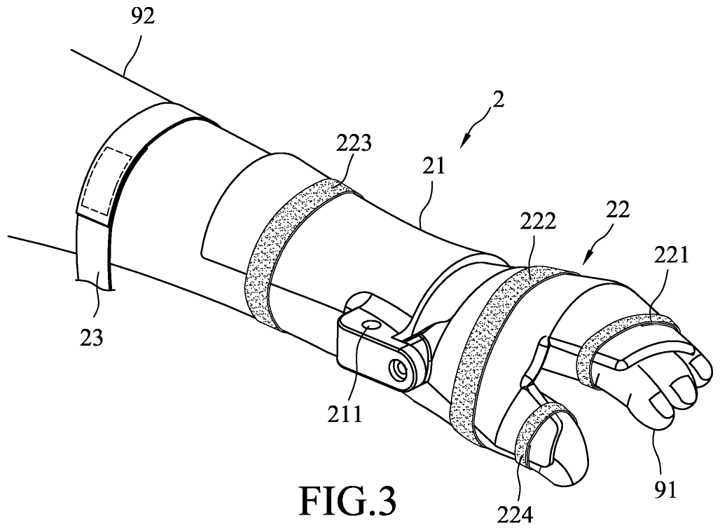

Referring to FIG. 3, the first strap set 22 has four straps 221, 222, 223, 224 for fixing the protective body 21 to the hand 91 and the forearm 92. The second strap 23 fixes the forearm 92 to the supporting portion 122 of the support 12. The strap 221 is fastened to and around the index, middle, and ring fingers of the hand 91. The strap 222 is fastened to the palm of the hand 91. The strap 223 is fastened to a front portion of the forearm 92. The strap 224 is fastened to the thumb of the hand 91. In this embodiment, each of the straps 221, 222, 223, 224 and the second strap 23 as exemplified, but not limited to, is a hook-loop strap.

Noteworthily, the number and arrangement of the first strap set 22 and the second strap 23 may vary in other embodiments.

When the user's elbow bends, the support 12 is swung by the forearm 92 through the wearable unit 2, so that the hand 91 and the forearm 92 are driven by the sliding unit 13 to rotate along the arcuate sliding rail portion 121.

The supporting frame 3 has a bottom seat 31 and a moving member 32 rotatably disposed on the bottom seat 31. The base 11 is fixed to the moving member 32. The bottom seat 31 is, but not limited hereto, fixed to a table. The moving member 32 can be, but not limited to, a multiple-joint assembly.

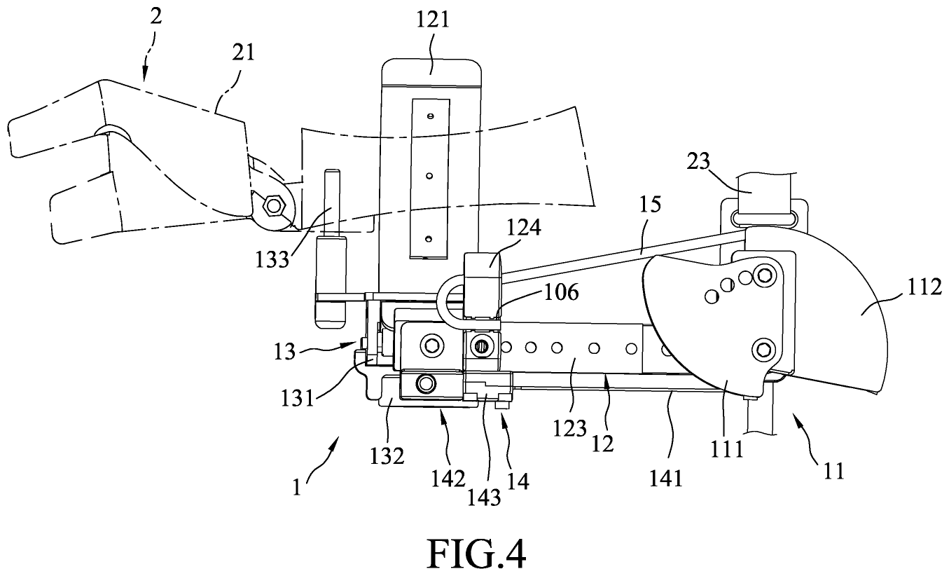

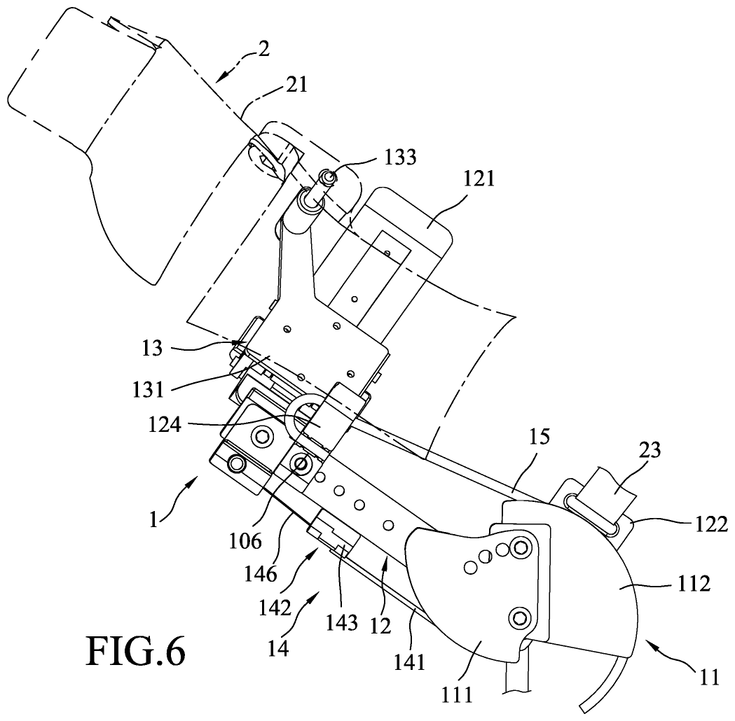

FIGS. 4 to 7 illustrates the use of the forearm synergy training device. To clearly illustrate connection between the assistive unit 1 and the wearable unit 2, the first strap set 22, the hand 91, the forearm 92 are omitted from the FIGS. 4 and 6.

In this embodiment, the forearm synergy training device of the disclosure is exemplarily used by the left forearm, whereas it can also be designed to be used by the right forearm. As shown in FIGS. 3, 4 and 5, the first strap set 22 fixes the protective body 21 to the hand 91 and the front portion of the forearm 92. The second fixing member 211 of the wearable unit 2 is fixedly engaged with the first fixing member 133 of the sliding unit 13. The rear portion of the forearm 92 is fixed to the supporting portion 122 (see FIG. 1) of the support 12 by the second strap 23. When the user's elbow is not bent, the user's palm faces downwardly and abuts against the sliding block 131, and the sliding unit 13 is located below the arcuate sliding rail portion 121 and away from the second fixed pulley member 145.

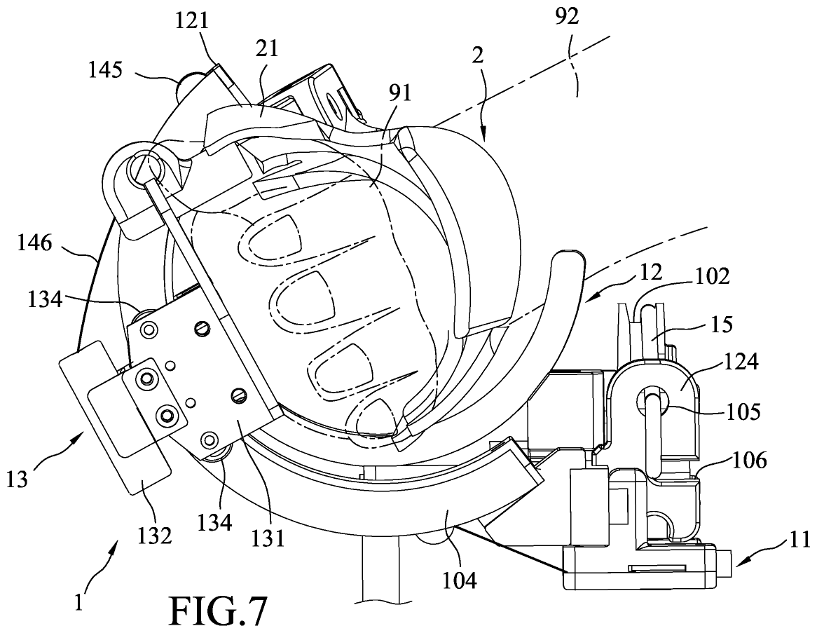

Referring to FIGS. 6 and 7, when the user's elbow bends so that the forearm 92 moves toward the user's body and drives the support 12 to be swung relative to the base 11, the synergistic assembly 14 drives the sliding unit 13 to slide upwardly along the arcuate sliding rail portion 121, and the hand 91 and the forearm 92 are driven by the sliding unit 13 to rotate along the arcuate sliding rail portion 121. After the sliding unit 13 slides to the uppermost of the sliding rail portion 121, the forearm 92 is moved downwardly by straightening the user's elbow to drive the support 12 to be swung forwardly and downwardly. As such, the fixed cord 141 is disengaged from the first arcuate cord slot 101, the pulling force is gradually diminished, and the sliding unit 13 moves toward the first fixed pulley member 144. The hand 91 and the forearm 92 are driven by the sliding block 131 to return to the state as shown in FIGS. 4 and 5. Therefore, when the user repeats elbow bending and straightening, the forearm synergy training device of the disclosure assists not only the forearm in flexion and extension, but also the forearm and the hand in rotation.

In summary, the forearm synergy training device of the disclosure assists the user in practicing rotation of the forearm and the hand while training flexion and extension of the forearm, thereby facilitating the user to practice more fine hand movements such as scooping and picking up. Further, the overall structure of the forearm synergy training device of the disclosure is relatively simple. The forearm synergy training device requires no power supply and is easy to use.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A forearm synergy training device, comprising:
an assistive unit including
a base,
a support swingable in a front-rear direction relative to and disposed on said base, and having an arcuate sliding rail portion,
a sliding unit movably disposed on said arcuate sliding rail portion, and
a synergistic assembly connected to said base, said support and said sliding unit, said synergistic assembly driving said sliding unit to slide along said arcuate sliding rail portion when said support is swung relative to said base; and
a wearable unit removably disposed on said support and said sliding unit, and adapted to be sleeved on a hand and a forearm of a user,
wherein, when the user's elbow bends, said support is swung by the forearm through said wearable unit, so that the hand and the forearm are driven by said sliding unit to rotate along the arcuate sliding rail portion.

2. The forearm synergy training device as claimed in claim 1, wherein:
said base has a cord guiding plate that has an arcuate cord slot formed in a bottom side thereof;
said synergistic assembly has a pulley-and-cord unit disposed movably on said support, and a fixed cord connected between said cord guiding plate and said pulley-and-cord unit, an end of said pulley-and-cord unit distal from said fixed cord being fixed to said sliding unit; and
when said support is swung relative to said base, said fixed cord generates a pulling force pulling said pulley-and-cord unit together with said sliding unit to move toward said base.

3. The forearm synergy training device as claimed in claim 2, wherein:
said support further has a supporting portion rotatably connected to said base, and a connecting portion connected between said arcuate sliding rail portion and said supporting portion;
said pulley-and-cord unit has a movable pulley member connected to said fixed cord, a first fixed pulley member disposed on a bottom side of said connecting portion, a second fixed pulley member disposed on a bottom end of said arcuate sliding rail portion distal from said connecting portion, and a movable cord connected between said connecting potion and said sliding unit;
said movable pulley member has a pulley seat disposed on said connecting portion of said support, a movable pulley rotatably disposed on said pulley seat, and a movable cover covering said pulley seat;
said first fixed pulley member has a first fixed pulley seat disposed on said connecting portion of said support, a first fixed pulley rotatably disposed on said first fixed pulley seat, and a first fixed cover covering said first fixed pulley seat;
said movable cord is disposed around said movable pulley, said first fixed pulley, and said second fixed pulley member; and
said sliding unit is disposed between said first fixed pulley member and said second fixed pulley member, said movable cord moving said sliding unit toward said second fixed pulley member through the pulling force generated by said fixed cord when said support is swung relative to said base.

4. The forearm synergy training device as claimed in claim 3, wherein:
said sliding unit has a sliding block, a cord reel, and a plurality of wheels;
said sliding block is slidably sleeved on said arcuate sliding rail portion, and has a main body, said main body having a top wall on which said wearable unit is disposed, two spaced-apart side walls extending respectively and downwardly from two opposite sides of said top wall, and a bottom wall connected between said side walls;
said wheels are rotatably disposed on inner surfaces of said side walls and abut against said arcuate sliding rail portion; and
said cord reel is disposed on said bottom wall; and
said movable cord is wound resiliently on said cord reel when the pulling force is applied to move said sliding unit.

5. The forearm synergy training device as claimed in claim 4, wherein said wearable unit includes a protective body removably disposed on a top side of said sliding unit, a first strap set having at least one strap adapted for fixing said protective body to the hand and the forearm, and a second strap adapted to fix the forearm to said supporting portion of said support.

6. The forearm synergy training device as claimed in claim 5, wherein said sliding unit further has a first fixing member disposed on said top wall of said sliding block, said wearable unit further including a second fixing member engaged with said first fixing member.

7. The forearm synergy training device as claimed in claim 6, wherein one of said first and second fixing members is a perforated hole, and the other one of said first and second fixing member is a pin.

8. The forearm synergy training device as claimed in claim 1, wherein said support further has a fixing portion, said assistive unit further including an adjustment belt connected between said base and said fixing portion under tension, said adjustment belt being operable to adjust an initial inclination angle of said support relative to said base.

9. The forearm synergy training device as claimed in claim 1, further comprising a supporting frame to which said base is fixed.

10. The forearm synergy training device as claimed in claim 9, wherein said supporting frame has a bottom seat and a moving member rotatably disposed on said bottom seat, said base being fixed to said moving member.
